(19) United States
(12) Patent Application Publication
(10) Pub. No.: US 2008/0005941 A1
(43) Pub. Date: Jan. 10, 2008

(54) Motorized display device for a cooler door

(76) Inventors: Bernard Primiano, Marietta, GA (US); James David Robertson, Atlanta, GA (US)

Correspondence Address: JOHN L. JAMES, P.O. BOX 2025, MARIETTA, GA, 30061-2025, US

(21) Appl. No.: 11/235,446

(22) Filed: Sep. 26, 2005

Related U.S. Application Data
(63) Continuation-in-part of application No. 10/994,919, filed on Nov. 22, 2004, now Pat. No. 7,293,381.

(51) Int. Cl. G09F 11/18

(52) U.S. Cl. 40/471

(57) ABSTRACT

A display device for an inside surface of a cooler door has a frame with a front panel and opposed first and second side panels. A top tube is mounted between the first and second side panels behind the front panel of the frame. A display scroll entrained about the top tube forms a top loop and a bottom loop. A bottom tube with opposed end flanges rides in the bottom loop of the display scroll with the end flanges retaining the bottom tube in the bottom loop. As the scroll is rotated about the tubes via a motor, a display graphic on the scroll moves to attract the attention of potential consumers.

### TECHNICAL FIELD OF THE INVENTION

This invention relates generally to a cooler, and, more particularly, to a motorized display device for a transparent cooler door.

### BACKGROUND OF THE INVENTION

Upright coolers in supermarkets and convenience stores typically have transparent glass doors so that the products inside are visible. It is now common to use the inside of the door for shelving as is done in household refrigerators. Door shelving fits against the door so that the product containers are visible, however the product labels do not always face forward for easy identification of the product. Some shelves have a small area for affixing product identification, but such small areas lack the impact needed, especially for impulse purchases. Accordingly, it will be appreciated that it would be highly desirable to have a cooler door display device with a large area for product labeling and identification.

Some coolers have display panels or other advertising material affixed to the front of the cooler door where it has maximum visibility. Some panels have raised portions to further increase visibility and interest. While such front panels and raised panels are highly visible, they present static images. Static images often lack the sensory impact needed to spur impulse buying. Accordingly, it will be appreciated that it would be highly desirable to have a cooler door display device with an attention grabbing feature.

### SUMMARY OF THE INVENTION

The present invention is directed to overcoming one or more of the problems set forth above. Briefly summarized, according to one aspect of the present invention a display device for mounting on an inside surface of a cooler door comprises a frame having a front panel and opposed first and second side panels. A top tube is mounted on the first and second side panels behind the front panel of the frame for rotational movement. A flexible display scroll is entrained about the top tube forming a top loop and a bottom loop. A bottom tube rides in the bottom loop of the display scroll.

As the scroll is rotated about the tubes by the top tube, a display graphic on the scroll moves to attract the attention of potential consumers. The display device provides a large area on the scroll for product labeling and identification. Being at the cooler door, the graphic remains visible at all times in contrast to actual product which may be located at the rear of the cooler shelf where it mat be difficult to recognize.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a front view of a preferred embodiment of a display device attached to the inside surface of an upright cooler door according to the present invention.

FIG. 2 is a perspective rear view of the display device of FIG. 1.

FIG. 3 is a diagrammatic side view of the display device of FIG. 1.

### DETAILED DESCRIPTION OF THE PREFERRED EMBODIMENTS

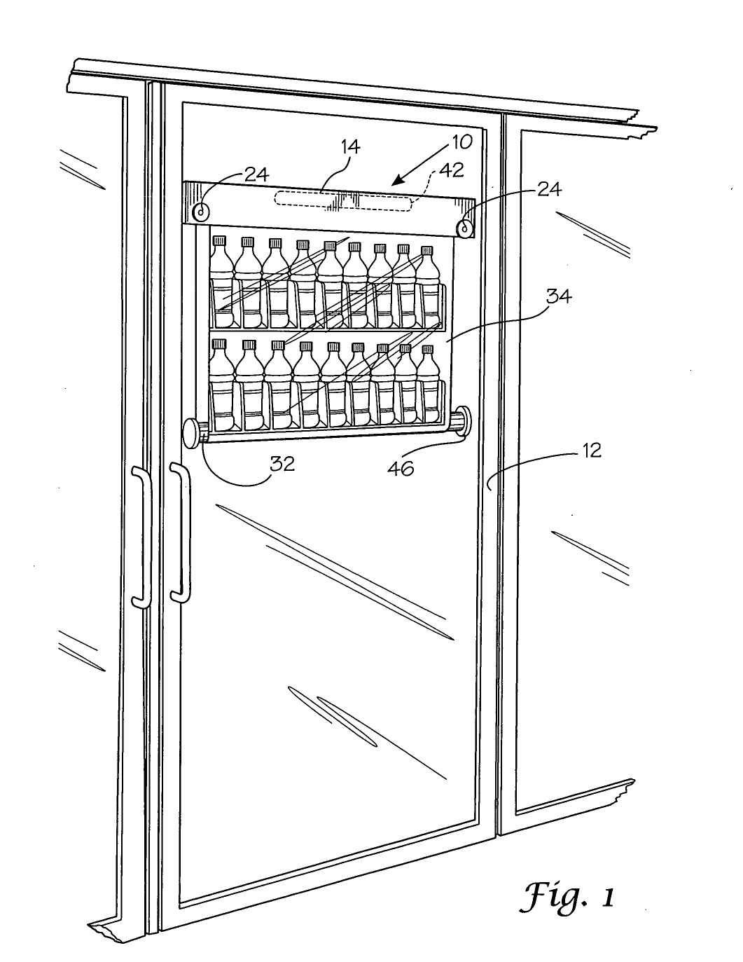

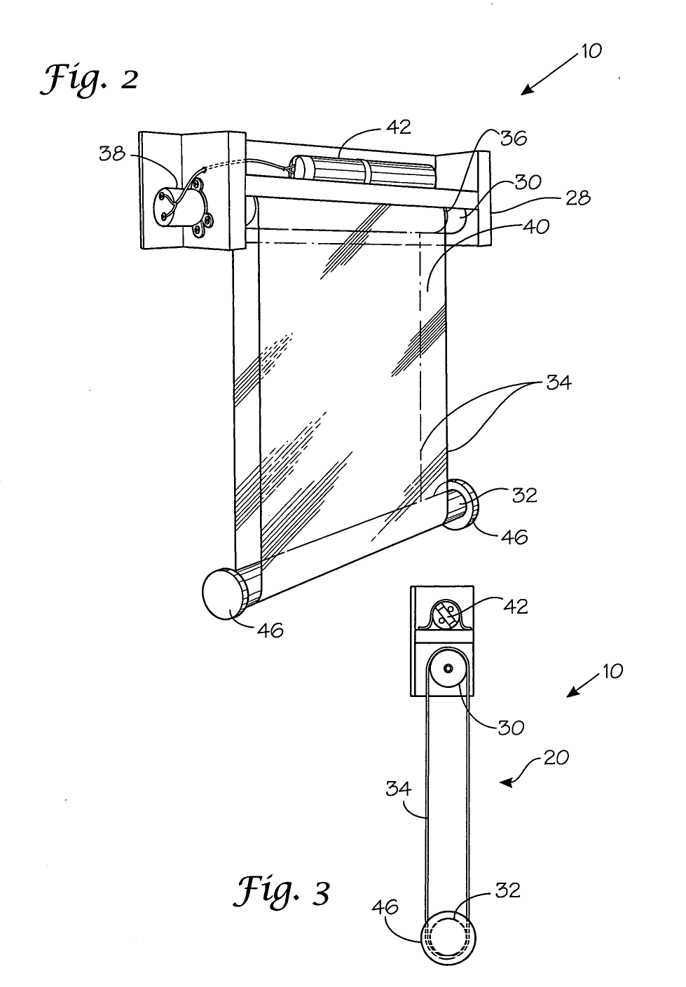

Referring to FIGS. 1-3, a display device 10 for an inside surface of a door 12 of a cooler such as those used for beverages and other refrigerated products. As illustrated, door 12 is hinged on the right and has a handle on the left for convenient opening by a right-handed consumer. Display device 10 has a frame with a front panel 14. The frame is preferably constructed of plastic, cardboard or the like and equipped with keyways 22 in front panel 14 to receive a protruding portions of suction cups 24.

Upright left and right end member 26, 28 are attached to the rear of front panel 14. Upright right end member 28 has an inside surface facing toward left end member 26, and upright left end member 26 has an inside surface facing toward right end member 28. An elongated boxy structure is formed by upright left and right end member 26, 28 and front panel 14.

A top tube 30 is mounted on the upright left and right end members 26, 28 and extends therebetween behind the front panel 14 of the frame so that it is hidden from view by a consumer. A display scroll 34 is entrained about top tube 30, so that the scroll is visible through the cooler door. The scroll 34 is preferably an endless piece of flexible material. To increase scroll traction, one or more rubber bands 36 may encircle top tube 30, or top tube 30 may be coated with a substance to increase friction and improve traction. A bottom tube 32 is mounted on the lower portions of the scroll. Bottom tube 32 has end flanges 46 that prevent bottom tube 32 from sliding off scroll 34.

A motor 38 powered by an energy pack or battery 42 and mounted behind front panel 14 provides a means for rotating display scroll 34. Motor 38 is preferably mounted behind front panel 14 so that it is not visible from the front.

While the invention has been described with particular reference to the preferred embodiments, it will be understood by those skilled in the art that various changes may be made and equivalents may be substituted for elements of the preferred embodiments without departing from invention. It is accordingly intended that the claims shall cover all such modifications and applications as do not depart from the true spirit and scope of the invention.

Element List

10 display device

12 cooler door

14 front panel

16 vacant

18 vacant

20 vacant

22 keyways

24 suction cups

26 left end member

28 right end member

30 top tube

32 bottom tube

34 display scroll

36 rubber band

38 motor

40 vacant

42 battery

44 vacant

46 bottom tube flanges

What is claimed is:

1. A display device for an inside surface of a cooler door, comprising:
a frame having a font panel and opposed first and second side panels;
a top tube mounted on said first and second side panels behind said front panel of said frame;
a display scroll entrained about said top tube forming a top loop and a bottom loop;
a bottom tube riding in said bottom loop of said display scroll; and
means for rotating said display scroll.

2. A display device, as set forth in claim 1, wherein said means for rotating said display scroll includes a motor.

3. A display device, as set forth in claim 2, wherein said motor is mounted on said front panel of said frame.

4. A display device, as set forth in claim 3, wherein said motor is attached to said top tube.

5. A display device, as set forth in claim 3, including at least one traction increasing device on said top tube adapted to increase traction between said scroll and said top tube.

7. A display device, as set forth in claim 1, wherein said bottom tube has opposed end flanges adapted to hold said bottom tube in said bottom loop of said scroll.

8. A display device, as set forth in claim 1, including:
means for mounting said frame, said frame defining keyways for receiving said mounting means.

9. A display device, as set forth in claim 8, wherein said mounting means includes a suction cup.
